(19) United States
(12) Patent Application Publication
(10) Pub. No.: US 2013/0031046 A1
(43) Pub. Date: Jan. 31, 2013

(54) DEVICES, METHODS, AND SYSTEMS FOR MODEL BASED DEGREE-OF-ANGLE LOCALIZATION

(71) Applicants: Steve Huseth, Plymouth, MN (US); Soumitri Kolavennu, Blaine, MN (US); Abhishek Kumar Singh, Bangalore (IN); Srinivasa Rao Katuri, Bangalore (IN)

(72) Inventors: Steve Huseth, Plymouth, MN (US); Soumitri Kolavennu, Blaine, MN (US); Abhishek Kumar Singh, Bangalore (IN); Srinivasa Rao Katuri, Bangalore (IN)

(73) Assignee: HONEYWELL INTERNATIONAL INC., Morristown, NJ (US)

(21) Appl. No.: 13/192,086

(22) Filed: Jul. 27, 2011

(51) Int. Cl. G06N 5/04

(52) U.S. Cl. 706/52

(57) ABSTRACT

Devices, methods, and systems for model based degree-of-angle localization are described herein. One device includes a memory and a processor. The processor is configured to execute executable instructions stored in the memory to construct a model of a number of signals, where the model includes a number of parameters. The processor executes the executable instructions to estimate the number of parameters and calculate range information of the number of signals. The processor executes the executable instructions to estimate a location of a transmitter transmitting the number of signals.

### TECHNICAL FIELD

The present disclosure relates to devices, methods, and systems for model based degree-of-angle localization.

### BACKGROUND

Localization detection (e.g., determining the location of a transmitter) can be an important part of rescue operations. For example, firefighters entering a dwelling that is on fire can become disoriented. If a disoriented firefighter wears a transmitter that emits a signal, localization detection can aid other firefighters in locating the disoriented firefighter.

Typical localization detection techniques with an array of antennas focus on transmitters as points in space. However, multipath dispersion effects (e.g., scattered signals due to reflection of the signals off objects in the environment) can cause an array to inaccurately detect the transmitter emitting the signals, in some instances. Arrays can, for example, be a uniform linear array (ULA) or a uniform circular array (UCA). An individual ULA or UCA can sample signals in one dimension. These devices can be helpful for localization, but have some limitations, such as their one dimensional nature.

### BRIEF DESCRIPTION OF THE DRAWINGS

FIG. 1 illustrates a system for model based degree-of-angle localization in accordance with one or more embodiments of the present disclosure.

FIG. 2 illustrates a method for model based degree-of-angle localization in accordance with one or more embodiments of the present disclosure.

FIG. 3 illustrates a uniform circular array of a computing device for model based degree-of-angle localization in accordance with one or more embodiments of the present disclosure.

FIG. 4 illustrates a computing device for model based degree-of-angle localization in accordance with one or more embodiments of the present disclosure.

### DETAILED DESCRIPTION

Devices, methods, and systems for model based degree-of-angle localization are described herein. For example, one or more device embodiments include a memory and a processor.

Benefits of embodiments of the present disclosure include, but are not limited to, generic modeling of degree-of-angle (DOA) localization, that can be applied via a number of rings in a multi-ring array and a number of receiving elements in each ring of the multi-ring array. Such modeling embodiments can provide the benefit of utilizing the same modeling process across different multi-ring array devices.

Benefits of such embodiments include, but are not limited to, simplifying the modeling method and/or procedure of a multi-ring array device. Embodiments of the present disclosure can, for example, provide models capable of DOA based localization in environments with multiple obstacles between a transmitting device and a receiving device. That is, embodiments can, for example, provide the benefit of DOA localization in environments where a direct line of sight between the transmitter and receive is lacking.

In some embodiments, the processor can be configured to execute executable instructions stored in the memory to construct a model of a number of signals, where the model includes a number of parameters. The processor can be utilized to execute the executable instructions to estimate the number of parameters and calculate range information of the number of signals. Range information can be calculated via a number of techniques including, but not limited to, a matrix pencil method. Range information can include, but is not limited to, the distance from the computing device or ring array location to the transmitter transmitting the signals. In some such embodiments, the processor executes the executable instructions to estimate a location of a transmitter transmitting the number of signals.

Devices, methods, and/or systems in accordance with one or more embodiments of the present disclosure can be utilized to localize signals. Some embodiments of the present disclosure can be utilized to localize signals in dense multipath environments, such as an indoor environment. Benefits of localizing signals in dense multi-path environments with a number of obstacles between the signal transmitter and the receiver can include more accurate signal localization, faster signal localization, and/or capability to localize a number of different transmitters.

Further, embodiments of the present disclosure can be utilized to construct models that are independent of the number of rings in a multi-ring array. Models that are independent of the number of rings can increase the versatility of the modeling method and/or procedure. For example, the same modeling procedure and/or method can be used on a multi-ring array of two rings and/or ten rings.

Various embodiments of the present disclosure can increase sampling resolution, for example, by adjusting the number of rings and receiving elements of the multi-ring array, without having to alter the distributed source model. This increasing of sampling resolution can provide the benefit of greater signal localization accuracy, in some instances. Further, increasing the number of receivers can increase the total number of signals received and therefore, increase the accuracy of signal localization.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

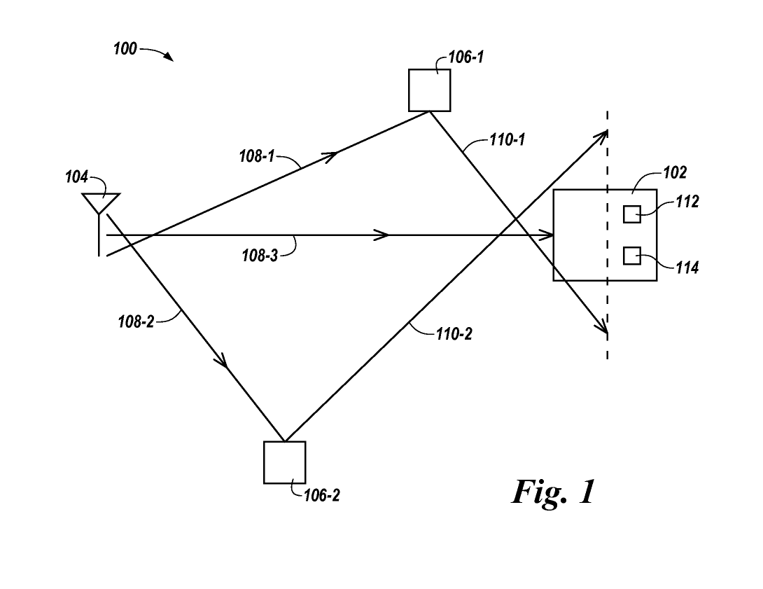

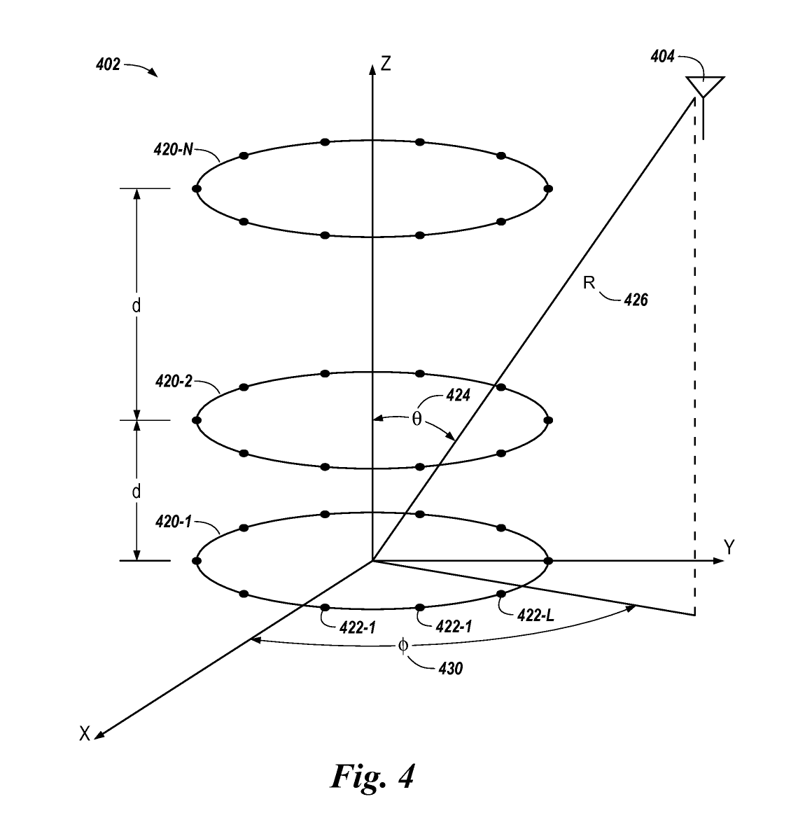

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 402 in FIG. 4.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of radio sensors” can refer to one or more radio sensors.

FIG. 1 illustrates a system for model based degree-of-angle localization in accordance with one or more embodiments of the present disclosure. In the embodiment illustrated in FIG. 1, system 100 is located in an environment. For example, the environment can be indoors, outdoors, and/or combinations thereof.

Indoor environments include, but are not limited to, dwellings, offices, buildings, warehouses, mines, sewers, etc. Outdoor environments include, but are not limited to, parks, forests, parking lots, construction zones, war zones, etc.

As shown in FIG. 1, system 100 includes a computing device 102. Computing device 102 includes a memory 112 and a processor 114 coupled to the memory. In one or more embodiments of the present disclosure, computing device 102 can be a multi-ring array as discussed below in connection with FIG. 4.

As shown in FIG. 1, system 100 includes a transmitter 104. Although the embodiment illustrated in FIG. 1 includes one transmitter, embodiments of the present disclosure are not so limited, and can include any number of transmitters located within system 100.

With respect to the present disclosure, a transmitter is a device that can emit (e.g., transmit) signals within an environment. As defined herein, signals can include, but are not limited to, electromagnetic (e.g., radio) waves that are modulated or continuous.

In the embodiment of FIG. 1, transmitter 104 transmits signals 108-1, 108-2, and 108-3. Although the embodiment illustrated in FIG. 1 illustrates three signals, embodiments of the present disclosure are not so limited, and can include more or fewer signals transmitted and in any of various directions in system 100.

In the embodiment illustrated in FIG. 1, signal 108-3 is transmitted directly to computing device 102. Such direct signals are referred to herein as direct line signals.

Signal 108-1, as illustrated by FIG. 1, reflects off an object 106-1. An object as used herein is any obstruction that interferes with a signal's direct path. Objects can include, but are not limited to, buildings, walls (natural or man made), trees, rocks, vehicles, etc. In FIG. 1, signal 108-2 reflects off object 106-2.

Signals 108-1 and 108-2 are received by computing device 102 as reflected signals 110-1 and 110-2, respectively. Reflected signals as used herein are referred to as scattered signals. In one or more embodiments, computing device 102 can receive direct line signals, scattered signals, and/or combinations thereof. For example, a computing device may receive both, direct line signals and scattered signals that have been reflected off of objects within the environment.

Such embodiments of the present disclosure can provide the benefit of not requiring direct line signals from a transmitter for signal localization. This allows for localization in dense multipath environments such as in a house or a mine. Further, embodiments of the present disclosure can, for example, construct a model that is independent of the source of the signal. That is, the constructed model can aid in signal localization with direct line signals, scattered signals, and/or combinations thereof.

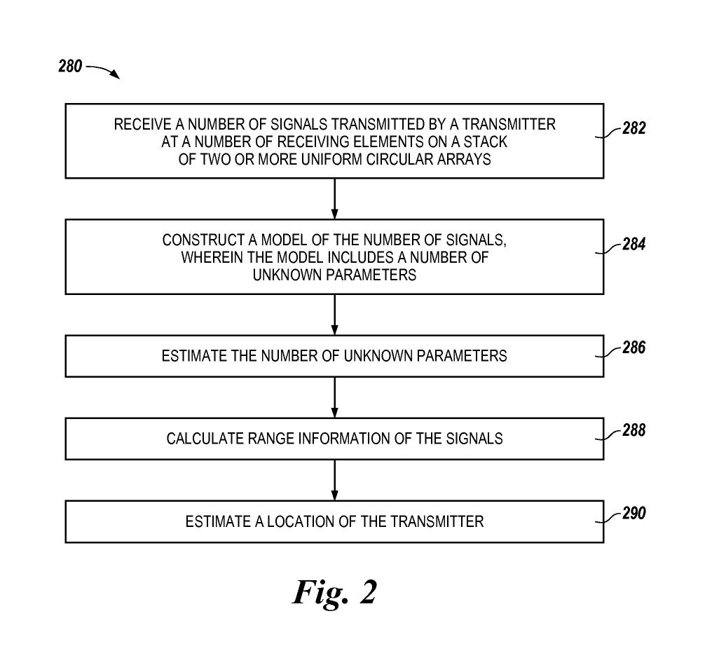

FIG. 2 illustrates a method 280 for model based degree-of-angle localization in accordance with one or more embodiments of the present disclosure. At 282, a number of signals transmitted by a transmitter are received at a number of receiving elements on a stack of two or more uniform circular arrays (UCAs).

A uniform circular array (UCA) is a circular array that has a number of uniform (e.g., evenly spaced) receiving elements. A receiving element is capable of intercepting and collecting a number of signals transmitted by a transmitter. One example of a receiving element is an antenna. A stack of UCAs can, for example, include a number of UCAs a known distance apart from one another. In one or more example, the UCAs can be vertically in line, stacked at an angle, stacked different vertical distances from one another, stacked different angles from one another, and/or combinations thereof, etc. For example, each UCA in a stack can be perpendicular to one another. In another example, Each UCA in a stack can be a distance above and/or below other UCAs in the stack and a known angle from the UCA directly above and/or below.

A model of the number of signals is constructed, 284, where the model includes a number of parameters. In one or more embodiments of the present disclosure, the model is constructed and positioned within the environment to receive signals that include a number of scattered signals and a number of direct line of sight signals.

In one or more embodiments of the present disclosure, the number of parameters can include an elevation angle parameter θ, an azimuth angle parameter φ, an azimuth angular spread parameter σ_{θ}, and/or an elevation angular spread parameter σ_{φ}. The constructed model can, for example, aid in identifying a location of a transmitter that is transmitting the signals.

In one or more embodiments, the constructed model is independent of the number of UCAs in the multi-ring array. That is, a method and/or procedure of constructing a model to aid in identifying a location of a transmitter according to embodiments of the present disclosure can, for example, be the same regardless of the number of rings and/or receiving elements in a multi-ring array.

Embodiments of the present disclosure can, for example, construct a distributed source model based a number of scattered signals. An example of a distributed source model, includes, but is not limited to:

$$x ( t ) = {\int }_{- π / 2}^{π / 2} a ( θ ) s ( θ , ψ , t ) d θ + n ( t )$$

For example, a(θ) represents a steering vector, x(t) represents a point source. s(θ, ψ, t)represents an angular signal density, θ represents a direction of arrival, ψ characterizes a spatial distribution of the source signal, and n(t) represents noise in the system.

As used herein, a steering vector represents a set of phase delays a plane wave experiences, evaluated at a receiving element. A point source is the source from which the signals are being transmitted. An angular signal density represents the number of signals received by the receiving elements within a certain arch angle (e.g., from 0 to 45 degrees of the x-axis).

A direction of arrival is the elevation angle at which the signal is received by the receiving element. Noise is the summation of random fluctuations in electrical signals and unwanted/disturbing energy from natural and/or man-made sources.

At 286, the method 280 estimates the number of parameters. In one or more embodiments, the number of parameters can be estimated via a weighted least square technique as discussed in connection with FIG. 4.

The multi-ring model can, for example, include symmetrical spatial sampling in both the azimuth and elevation planes to achieve a more accurate angle of arrival computation. As discussed below, elevation angular accuracy can be increased, for example, by increasing the elevation aperture. Elevation aperture can be increase by increasing the number of elements in vertical plane (e.g., stacking UCAs on top of each other

Embodiments of the present disclosure, can, for example, estimate an angle of arrival (AOA) of the received signals as one of the elements. AOA measurement is a method for identifying the direction of a signal transmitted by a transmitter. AOA can consider the time difference of arrival (TDOA) of a number of signals at the number of elements of each ring of the multi-ring array. The AOA can include an azimuth AOA and/or an elevation AOA.

Range information can be calculated at 288. Range information can include, for example, the distance to the transmitter that is transmitting the signals. Range information can be calculated via a number of techniques including, but not limited to, a matrix pencil method.

In one or more embodiments, the matrix pencil method can include a covariance matrix, as discussed in connection with FIG. 4. At 290, a location of the transmitter is estimated. In one or more embodiments of the present disclosure, the location can be identified by a number of parameters, including, but not limited to, a range distance, an elevation angle parameter θ, an azimuth angle parameter φ, an azimuth angular spread parameter σ_{θ}, an elevation angular spread parameter σ_{φ}, and/or combinations thereof. The number of parameters can be utilized in the constructed model to determine a distance to the transmitter and/or and angle from the receiver to the transmitter to aid in signal localization.

In one or more embodiments, a desired accuracy can be achieved by altering the number of receiving elements per UCA and/or altering the number of UCAs in the multi-ring array. For example, increasing the number of receiving elements can increase the accuracy of the location determination of the transmitter.

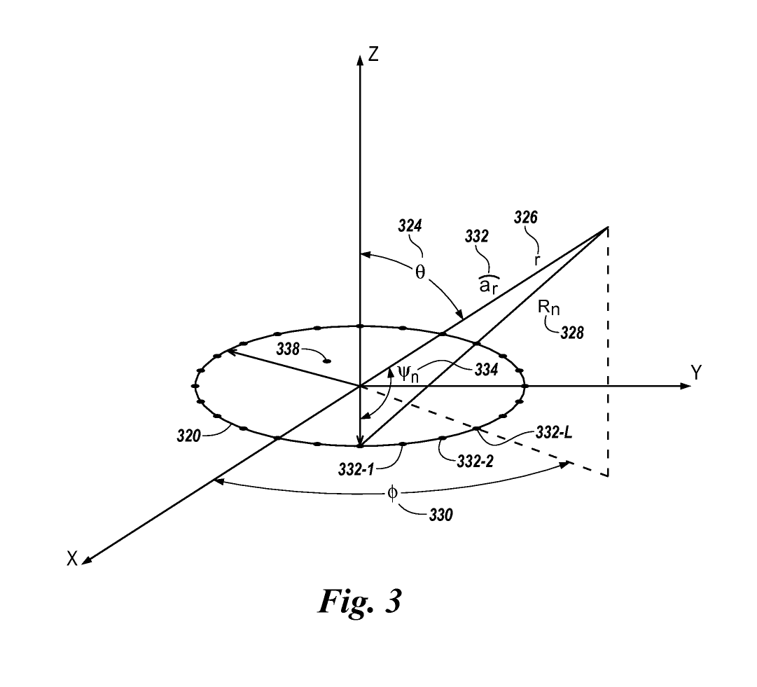

FIG. 3 illustrates a uniform circular array (UCA) 320 of a computing device for model based degree-of-angle localization in accordance with one or more embodiments of the present disclosure. The embodiment illustrated in FIG. 3 has a number of receiving elements 322-1, 322-2, . . . , 322-L, where L represents a number of receiving elements.

As illustrated in FIG. 3, θ is Elevation Angle 324, φ is Azimuth Angle 330, an angle of arrival (AOA) 332, a is Radius of the UCA 338, r is the distance from a transmitter to the origin of the computing device 326, and Rₙ is the distance from a receiving element to the transmitter 328. In one or more embodiments, a scattered source can be distributed as a coherently distributed source.

For example, when a location of the source of the scattered signals does not change temporally (e.g., the shape of the angular distribution does not change temporally) and the scattered signals received from that source at different angles are fully correlated, the distributed source can be said to be a coherently distributed source. That is, for a coherently distributed source, the signal components arriving form different directions can be modeled as the delayed and attenuated replicas of the same signals. For example, a coherently distributed source can include:

x(t)=∫∫a(θ,φ)s(t)ρ(←,φ;μ)dθdφ+n(t);

where x(t) is an array output vector, ρ(θ, φ, μ) is a deterministic angular weighting function of θ and φ but not of t, and is parameterized by the vector μ=(θ, σ_{θ}, φ, σ_{φ}) denoting the nominal elevation direction of arrival (DOA) θ, angular extension ν_{θ} of the elevation DOA, the nominal azimuth DOA φ, and angular extension σ_{φ} of the azimuth DOA, and a(θ,φ)=[e^{jη sin θ cos(φ-γ}^{₁}⁾·e^{jη sin θ cos(φ-γ}^{₂}⁾·e^{jη sin θ cos(φ-γ}^{_{L}}⁾]^{T} is the steering vector for the UCA: where j=\sqrt{−1}; η=2πr/λ; and γₖ=2π(k−1)/L for k=1, 2 . . . , L, with r as the radius of the UCA and λ the wave length of the arriving wave (e.g., signal).

The coherently distributed source model can be represented by:

x(t)=s(t)b(θ,σ_{θ},φ,σ_{φ})+n(t);

where b(θ, σ₇₄, φ, σ_{φ}) is the steering vector. For example, the coherently distributed source model above can have a deterministic angular weighting function ρ(θ, φ; μ) of Gaussian shape:

$$ρ ( ϑ , ϕ ; μ ) = \frac{1}{2 π {σ}_{θ} {σ}_{φ}} {e}^{- 1 / 2 ( {( \frac{ϑ - θ}{{σ}_{θ}} )}^{2} + {( \frac{ϕ - φ}{{σ}_{φ}} )}^{2} )} .$$

Then, the steering vector b(θ, σ_{θ}, φ, σ_{φ}) for the distributed source model can be written as:

[b(θ,σ_{θ},φ,σ_{φ})]ₖ≈[a(θ,φ)]ₖ·e^{-η}^{²}^{(σ}^{_{θ}}^{²} ^{cos} ^{²}^{θ cos} ^{²}^{(φ-γ}^{ₖ}^{)+σ}^{_{φ}}^{²} ^{sin} ^{²}^{(φ-γ}^{ₖ}⁾⁾.

The steering vector can account for a nominal elevation angle-of-arrival (θ), spread in elevation angle-of-arrival (σ_{B}), a nominal azimuth angle-of-arrival (φ) and a spread in azimuth angle-of-arrival (σ_{φ}). The steering vector can, for example, can account for receiving signals from both azimuth and elevation planes (3-dimensional) from the target radio. That is, it is a mathematical model of the multi-ring array which accounts for the distributed source model in 3-dimension.

The constructed model can resemble an environment (e.g., indoor/outdoor) and a statistically optimum estimation technique (e.g., maximum-likelihood) or semi-optimal technique (e.g., weighted least squares) can be applied to estimate the angle-of-arrival in both azimuth and elevation planes, and a matrix pencil method can aid in extracting the range parameters, and the fusion of all three parameters used for identifying the location of a transmitter that is transmitting the signal

FIG. 4 illustrates a computing device 402 for model based degree-of angle localization in accordance with one or more embodiments of the present disclosure. FIG. 4 illustrates a multi-ring antenna array computing device 402. Multi-ring antenna array 402 includes three UCAs 420-1, 420-2, . . . , 420-N, where N represents the number of UCAs in the array. FIG. 4 illustrates extending a two-ring array model to a multi-ring array including more than two rings.

Although the embodiment illustrated in FIG. 4 illustrates three UCAs, embodiments of the present disclosure are not so limited, and can include more or fewer UCAs. Each UCA 420-1, 420-2, . . . , 420-N contains a number of receiving elements 422-1, 422-2, . . . 422-L, where L represents the total number of receiving elements per UCA. FIG. 4 illustrates a transmitter 404 a distance R from the computing device 402.

FIG. 4 illustrates a number of UCAs (N) physically displaced from each other by a known distance d vertically. In an example, the distance d can vary between each UCA. The origin of the spherical coordinate system is located at the center of the UCA 420-1.

The spherical coordinate system is a three-dimensional graphical representation of an environment. Three numbers can represent any point in space: the radial distance from a fixed point (e.g., R, 426); the elevation angle from a fixed zenith direction (θ, 424); and an azimuth angle (φ, 430) measured from a reference plane (e.g., x-y plane). For example, the three numbers can represent the location of a transmitter relative to a computing device (e.g., receiver).

Receiving elements of the UCAs are displaced by the

angle

$${γ}_{k} = \frac{2 π ( k - 1 )}{L} ,$$

for k=1, 2, . . . , L, from the x axis. That is, receiving elements can, for example, be numbered starting in the positive direction from the x-axis, with receiving element 1 (e.g., 402-1). The position vector of each location is p_{N}=(r cos γₖ, r sin γₖ, −(N−1)d), respectively.

When a signal with a wave value k₀=2π/λ, for example, propagates in direction −r, the phase difference between the received signal at the origin and the received signal at element k of array 420-N is ψₖ₁=e^{j·k}^{₀}^{r·p1}=e^{j·η·sin θ·cos(φ=γ}^{ₖ}⁾ and ψ_{kN}=e^{j·k}^{ₒ}^{·r·pN}=e^{j·η·sin θ·cos(φ-γ}^{ₖ}⁾e^{-j·k}^{₀}^{·d·cos θ} in UCAs 420-1 and 420-N, respectively.

The received signal vector in UCA 420-1 can be expressed as y(t)=s(t)c(θ, σ_{θ}, φ, σ_{φ})+v(t), for example, when

$$c ( θ , {σ}_{θ} , φ , {σ}_{φ} ) \approx b ( θ , {σ}_{θ} , φ , {σ}_{φ} ) \cdot exp ( - j \cdot \frac{2 π . Nd}{λ} cos θ )$$

for small angular extensions, which in the matrix form can be written as C≈B.φₚ where:

$${Φ}_{P} = diag ( exp ( - j \frac{2 π . Pd}{λ} ) cos θ )$$

$$z ( t ) = Γ s ( t ) + u ( t ) .$$

The total array output vector z(t)=[x₁(t), x₂(t), . . . x_{N}(t)]^{T} can be written as: z(t)=γs(t)+u(t); where γ=[B, BΦ₁, . . . , B.Φ_{N}]^{T} and u(t) is the noise vector. This will provide a constructed covariance matrix as:

R_{z}=E{z(t)Z^{H}(t)}

In one or more embodiments, the number of parameters can be estimated via a maximum likelihood technique. For example, using the sampled array covariance matrix R and the constructed covariance matrix R_{Z}, the log-likelihood function can be:

L(θ,σ_{θ},φ,σ_{φ})=log(R_{Z})+Tr{R_{Z}⁻¹·R}.

Finding the minima of the L can give the value of the desired parameters. Finding a value of the parameters can be beneficial, for example, to provide a three-dimensional location of a transmitter transmitting a number of signals relative to the receiver receiving the signals.

In one or more embodiments, the number of parameters can be estimated via a weighted least squares technique. For example, the weighted least squares criterion can be written as:

L=Tr{(R_{Z}R⁻¹−l)²}

Minimizing the parameter L can give the value of the parameters using the least squares criterion. As discussed above, finding a value of the parameters can provide a three-dimensional location of a transmitter transmitting a number of signals relative to the receiver receiving the signals.

Embodiments of the present disclosure provide devices, methods, systems for model based degree-of-angle localization. Embodiments can construct models that are independent of the type of signal received (e.g., direct line or scattered). Benefits can include, but are not limited to, signal localization in dense multipath environments, unified model construction in a number of different arrays, etc.

Further, embodiments of the present disclosure can provide an added benefit of constructing models independent of the number of ring arrays in the multi-ring array and/or the number of receiving elements per ring array. Therefore, distributed source models of the present disclosure can be applicable to a number of different types of multi-ring arrays.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for model based degree-of-angle localization, comprising:
a memory; and
a processor configured to execute executable instructions stored in the memory to:
construct a model of a number of signals, wherein the model includes a number of parameters;
estimate the number of parameters;
calculate range information of the signals; and
estimate a location of a transmitter transmitting the number of signals.

2. The computing device of claim 1, wherein:
the computing device includes two or more stacked rings of uniform circular arrays, wherein each of the two or more rings include a number of receiving elements configured to receive the number of signals emitted from the transmitter; and
the processor is configured to execute executable instructions stored in the memory to:
construct the model based on the number of received signals independent of the number of rings of the stacked array.

3. The computing device of claim 2, wherein:
the receiver is configured to receive the number of received signals as scattered signals from the transmitter; and
the processor is configured to execute executable instructions stored in the memory to:
construct the model based on the scattered signals as a distributed source model.

4. The computing device of claim 1, wherein the executable instructions to estimate the number of parameters include instructions to estimate an elevation angle parameter, an azimuth angle parameter, an azimuth angular spread parameter, and an elevation angular spread parameter.

5. The computing device of claim 4, wherein the executable instruction to estimate the location of the transmitter includes instructions to estimate the location based on the calculated range information, azimuth angle parameter, and elevation angle parameter.

6. The computing device of claim 2, wherein:
the two or more stacked rings of uniform circular arrays included in the computing device collect the signals received by the receiving elements; and
the processor is configured to execute executable instructions stored in the memory to estimate the number of parameters via a maximum likelihood estimation technique or a weighted least square technique.

7. The computing device of claim 1, wherein the number of receiving elements are configured to receive a number of modulated signals or a number of continuous wave signals.

8. A method for model based degree-of-angle localization, comprising:
receiving a number of signals transmitted by a transmitter at a number of receiving elements on a stack of two or more uniform circular arrays;
constructing a model of the number of signals, wherein the model includes a number of parameters;
estimating the number of parameters;
calculating range information of the signals; and
estimating a location of the transmitter.

9. The method of claim 8, wherein receiving the number of signals includes receiving a number of scattered signals and a number of direct line of sight signals.

10. The method of claim 8, wherein estimating the number of parameters includes estimating an elevation angle parameter, an azimuth angle parameter, an azimuth angular spread parameter, and an elevation angular spread parameter.

11. The method of claim 8, including adjusting the number of uniform circular arrays of the stack to obtain a desired accuracy level of the estimation of the location of the transmitter.

12. The method of claim 8, wherein estimating the number of parameters includes estimating via a weighted least square technique or a maximum likelihood estimation technique.

13. The method of claim 8, wherein constructing a model of the number of signals includes constructing a distributed source model.

14. The method of claim 8, wherein the range information of the signals is calculated via a matrix pencil method.

15. A system for model based degree-of-angle localization, comprising:
a computing device including a stack of two or more uniform circular arrays, the uniform circular arrays including a number of receiving elements, the computing device configured to:
receive a number of signals at the number of receiving elements on the stack of two or more uniform circular arrays, the number of signals transmitted by a transmitter;
construct a distributed source model of the number of signals, wherein the model includes an elevation angle parameter, an azimuth angle parameter, an azimuth angular spread parameter, and an elevation angular spread parameter;
estimate the number of parameters;
calculate range information of the number of signals; and
estimate a location of the transmitter.

16. The system of claim 15, wherein the number of signals includes a number of scattered signals that have reflected off a number of obstacles between the transmitter and the computing device.

17. The system of claim 15, wherein the number of uniform circular arrays are adjusted to obtain a desired accuracy level of the estimation of the location of the transmitter.

18. The system of claim 15, wherein the number of receiving elements are adjusted to obtain a desired accuracy level of the estimation of the location of the transmitter.

19. The system of claim 15, wherein the constructed distributed source model does not take into affect the number of stacked rings in the computing device.

20. The system of claim 15, wherein the location of the transmitter is estimated at desired time interval.
